(19) United States
(12) Patent Application Publication
(10) Pub. No.: US 2019/0085814 A1
(43) Pub. Date: Mar. 21, 2019

(54) Energy Storage Process and System

(71) Applicant: Roy Bee, Virginia Beach, VA (US)

(72) Inventor: Roy Bee, Virginia Beach, VA (US)

(21) Appl. No.: 16/138,882

(22) Filed: Sep. 21, 2018

Related U.S. Application Data
(60) Provisional application No. 62/606,372, filed on Sep. 21, 2017.

(51) Int. Cl. F03B 13/06; F03D 9/17; F03B 13/10

(52) U.S. Cl. CPC F03B 13/06; F03B 13/10; F03D 9/17

(57) ABSTRACT

An energy storage method and system includes a collapsible bladder that is filled with water at depth. The bladder may be lowered to additional depths to increase the pressure experienced within the bladder and to increase the stored energy. In a preferred embodiment, over produced electricity is used to pump water into a bladder. During periods of high electricity demand, pressurized water within the bladder is directed through a conduit to turn turbines of generators and produce electricity. Two large all-thread screws are attached to the bladder and anchored to the seafloor or at or near a bottom of a body of water. Associated threaded mechanisms are connected to the exterior of the bladder such that when the all-thread screws are turned, the bladder is raised and lowered within the water to vary the internal pressure. In this manner, the bladder is lowered or anchored deeper as needed to produce additional pressure. Energy needed to lower the bladder may be recovered during the deflation process or in high excess energy production times where demand is low. The bladder may be used to store fresh water and reused as necessary. Controlled operation of the procedure may be performed through use of PLCs and coupled to sensors and actuators.

The present invention relates to U.S. Provisional Patent Application Ser. No. 62/606,372 with a filing date of Sep. 21, 2017 and claims priority therefrom.

The present application was not subject to federal research and/or development funding.

### TECHNICAL FIELD

Generally, the present invention relates to an energy storage process and system comprising a sunken collapsible bladder containing pressurized fluid or water which is controllably released to power at least one turbine to generate electricity for use during high demand periods of time. More particularly, the invention is a bladder that is filled with fluid during periods of low use electricity at a great enough depth that the weight of water above the bladder pushing down on it forces fluid within the bladder through a conduit to drive a turbine and produce electricity. The invention is beneficial in that it stores energy produced in periods of lower demand and/or higher production. When electricity demand is increased, the stored energy is released back onto the electrical grid to meet consumer demand. In an emergency, the bladders, which may contain fresh uncontaminated water, may be harvested as a fresh water supply or a producer of electricity. For example, emergency responders may drain the bladder to obtain potable water during emergency situations; Or, the bladder may be drained to produce electricity or a combination thereof.

### BACKGROUND OF THE INVENTION

Green energy includes electricity produced by solar panels and wind turbines. Since the sun does not continuously shine and the wind does continuously blow, such green energy production devices require the use of storage devices. Batteries have been utilized to store electricity for use during nighttime hours or when the wind is not blowing. The batteries are then drained during periods of high electricity demand when there is no light and/or wind. However, battery technology has not progressed over the years causing the cost of such storage to be great. Moreover, the size of batteries necessary to store such electricity is large.

Thus, many have sought other methods of storing electricity produced during low demand periods of time for use in later high demand periods of time. As energy comes in multiple forms including radiation, chemical, potential, heat and kinetic, there are a variety of proposed methods for storing such electricity in different forms. If batteries or capacitors are not used, the electricity is converted into a different form of energy that is not difficult to store. Such storage methods include pumping water into a storage reservoir with a higher elevation to drive turbines by releasing it during periods of higher electricity demand. Other storage methods include chemical storage which comprises using the over produced electricity to break down water into hydrogen and oxygen and burning them or converting the electricity to heat which is then recaptured.

US Patent Publication Number 20110109089 A1 to Frye teaches an enablement that is a submerged hydro-powered electrical generating plant powered by the raw power of ocean currents by using the natural motive forces of nature, when submerged within a moving ocean current. A turbine driven electrical generator (preferably a Pelton wheel impulse turbine), with a transformer are all located in an enclosing water tight structure, extended downward from a floating surface operating platform. The prime mover, which is a water supply from incoming ocean currents, applies that force to a turbine, then is exhausted as spent water through a conduit exhausting system that feeds into an entrainment chamber of a Venturi/Eductor jet pump assembly. The motive force for the pump is the incoming ocean currents. The spent water exits the pump as a discharge back into the downstream current. On the power side, the force for this embodiment is derived from the velocity of the moving current and the pressure and mass volume of the depth flowing through the turbine unit and rotating the electrical power generator. This enablement makes available the energy of moving water which can be used to power other embodiments within or outside the structure or above the surface of the water, such as desalination of water by reverse osmosis membranes or electrolysis of water to create hydrogen as a liquid fuel and oxygen as a byproduct, or any other technological process. It is applicable to any comparable moving fluid source, particularly water. This enablement performs the same function as an underwater hydro-powered dam, capable of producing electrical energy, without consuming fossil fuels or causing adverse environmental or economic effects. It can achieve even higher pressures (head) as a motive force to drive its turbine, if it is coupled and operated as a combined system, which includes a means for hydraulic pressure.

U.S. Pat. No. 7,471,009 B2 to Grillos discloses an apparatus for a turbine that generates electrical power from water or air flow comprising at least one rotor disk having a plurality of hydrofoil blades, guide vanes, a cylindrical housing, and a generator means. A rim generator comprising a magnet race rotor rim and fixed stator coils in the housing is used. The apparatus is fitted with a screen to stop the ingress of debris and marine life, and a skirt augmenter device to reduce the Betz effect. The apparatus is preferably for sub-sea deployment and driven by tidal currents, but may be powered by river current or wave driven air or by wind. The apparatus may be deployed on at least one telescoping pole, tethered to the sea-bed and kept buoyant by buoyant concrete in the housing, inserted in a dam, under a barge or in a tidal power array.

US Pat. Pub. No. 20090021012 A1 to Stull et al. teaches a method and apparatus for using wind energy to compress air or pressurize a fluid as a means of storing energy. Compressed air or pressurized fluid is generated directly by the wind turbines, thereby avoiding the energy losses that occur when wind power is used first to generate electricity to run an electrically powered air compressor. The compressed air or pressurized fluid is stored by means of expanding a volume at constant or nearly constant pressure. This method avoids energy losses that would otherwise result from compressional heating; while also allowing lower pressures to be employed, reducing the cost of the containment facility and avoiding the need to locate facilities in geographically favored locations where underground storage is available. The invention permits both large and small-scale storage at low cost per unit of energy stored, thereby avoiding the difficulty of using a highly variable and unreliable source of energy such as the wind for electrical power generation. The invention can be used for generation and storage on land, in shallow near-shore waters and in deep-water locations far from shore.

US Patent Publication Number 20150316034 A1 to Johnston discloses a water relocation apparatus is provided which uses water as a means for transferring energy from the wind and sun into electricity. Wind and the sun may be used to displace water from a water container means. The water container means has a water container member which may be partially submerged in a water supply or reservoir, or it may be connected remotely. The water container means also has a water transport member connected to it, through which water from the water reservoir may move into the water container member. The water from the supply or reservoir will move into the water container member as the water displacement process begins. A conventional windmill system may be used to mechanically displace the water, or an evaporation system utilizing one or more lenses may be used to evaporate the water. An electric generator means may be operatively connected to the water container means in such a manner that the movement of the water through said water transport member may be used to generate electricity. In an alternate configuration, a water condenser means may be connected to the water container means in such a manner that the evaporated water may be transformed back into liquid form and returned to the reservoir or collected for possible residential, commercial, or industrial uses. The various components of the water displacement means and electricity generation means, along with the water condenser means, may also be used in various combinations to displace larger amounts of water.

### SUMMARY OF THE INVENTION

It is a primary aim of the present invention to store over produced electricity in a safe cost-effective manner and return the stored energy back onto the grid when there is a peak electricity demand. In one instance, a large collapsible bladder is lowered into a body of water and filled with water using over produced or excess electricity. At least one flexible conduit connects to the collapsible bladder for filling and draining purposes. In one instance, the flexible conduit is opened to direct fluid into the bladder until it is full; thereafter, the conduit may be opened to drain the bladder by directing pressurized fluid through a turbine during periods of high electrical demand such as when the populations of large cities wake up and get home. Thus, the system serves as a storage device for producing electricity and to advantageously aid in the production of electricity and stabilization of the electric grids. In another embodiment, a collapsible bladder may be permanently situated near the bottom of a body of water and filled and emptied as need to drive a turbine to produce electricity during peak demand periods.

The weight of air at sea level exerts about 14.7 psi on the body. This amount of pressure is called one atmosphere of pressure because it is the amount of pressure the earth's atmosphere exerts downward onto someone. Underwater pressure measurements may be provided in units of atmospheres. It is recognized that underwater pressure directly correlates with depth. The instant invention uses the principle that the deeper an object descends, the more water it has pushing and weighing upon it to thereby exert more pressure on the exterior of the object and increase an internal pressure. In this instance, the object is a collapsible tank or bladder. For every 33 feet of depth of decent in sea water, an increase of one atmosphere of pressure is experienced. Thus, a bladder sunk to a depth of 100 feet should experience greater than 3 atmospheres of pressure being exerted upon its exterior. Pressurized fluids or water contained within the collapsible bladder is then directed through a conduit to drive a turbine to produce electricity. The electricity is preferably fed back onto an electrical grid during peak demand periods of time to stabilize the grid.

In a preferred embodiment, electricity is used to pump a fluid into a bladder during daylight hours or hours of low electrical demand. At night or during overcast periods, the bladder is emptied to turn generators and produce power which may be fed back onto an electrical grid. In a first embodiment, two large all-thread screws are attached to the bladder and anchored to the seafloor. In this manner, the bladder is forcibly descended as needed to produce additional internal pressure which is harnessed by releasing the compressed contents of the bladder. Energy needed to lower the bladder may be recovered during the deflation process. The bladder may be used to store fresh water and reused as necessary.

It is an object of the invention to provide an energy storage system comprising a storage bladder that is lowered in a body of water to create a pressurized water source which is then harnessed to produce electricity during peak demand periods. Otherwise, a submerged bladder may be inflated at an operating depth when electricity is cheap and stored at depth until released to produce electricity during peak demand periods of electricity.

It is another object of the invention to provide an environmentally safe and cost-effective method of storing electricity which is over produced and stored for later use.

Additional objects and advantages of the invention will be set forth in part in the description which follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1 shows the preferred embodiment of realizing the invention.

FIG. 2 shows another embodiment of the invention.

FIG. 3 shows a further embodiment of the invention.

FIG. 4 is an electrical schematic showing an embodiment of the invention.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

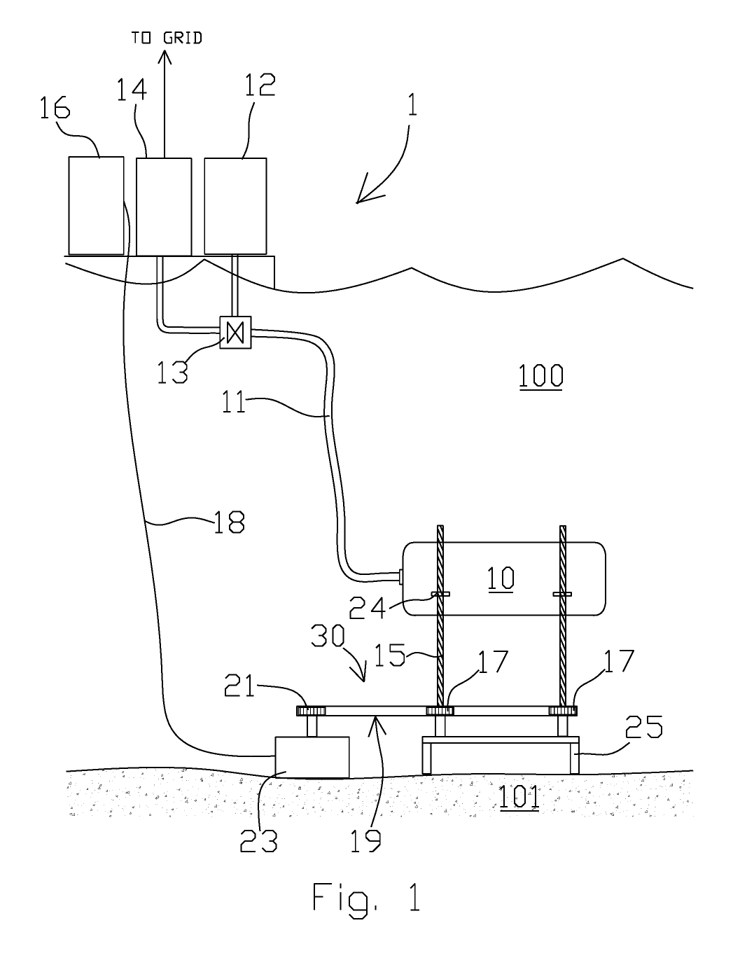

FIG. 1 shows an embodiment of the invention 1 wherein part of the system is immersed within water 100. In this instance, a bladder or ballast 10 is arranged beneath the surface of the water 100. A flexible conduit 11 connects to the bladder 10 at one end and to a diverter valve 13 which includes a common port and two switchable ports. The common port connects to the flexible conduit 11. One of the switchable ports connects to the generator 14; the other connects to a pump 12. In a first position, the pump 12 is fluidly connected to the flexible conduit 11 for filling the bladder 10 by allowing fluid to be driven from the pump 12 and into bladder 10. In a second position, fluid from within bladder 10 is diverted into the generator 14 to produce electricity. That is, water or other fluid which is contained within the bladder 10 is filled via pump 12. Thereafter, the fluid contained within the bladder 10 is drained through the diverter valve 13 and into the generator 14 which includes a turbine that produces electricity. Battery 16 accepts energy from the generator 14. Electricity produced from the generator 14 is also deposited onto the electrical grid. The instant invention receives electricity to submerge a bladder to an operating depth whereby potential energy is stored within the bladder and thereafter released to produce electricity during peak demand. When electricity is being produced at the cheapest rate, such as when there is a large production and a smaller demand, the bladder is filled with fluid. The bladder 10 may be lowered to a deeper depth via a pair of screw drives 15 which are driven via a synchronized chain drive 30. Each screw drive 15 includes an exterior thread thereon. A motor 23 is mounted on the bed of the body of water 101. A drive gear 21 turns a chain 19 or belt to drive a gear 17 arranged at an end of each screw drive 15 to raise or lower the bladder 10 as threaded mounts 24 move up and down a respective screw drive 15. The motor 23 turns the synchronized chain drive 30 and is coupled to a power cord 18 which is connected at the surface to a power source, such as a solar panel, wind turbine or battery 16. The synchronized chain drive 30 is preferably fastened to the bottom of the body of water or sea floor. As, the screw drives 15 are turned, the bladder 10 raises or lowers in the water to aid in the filling of the bladder 10 or production of electricity. In this manner, the internal pressure of bladder may be increased or decreased. Pressurized water, or other such fluid, may be directed from within the bladder towards the surface to drive one or more turbines which are used to produce electricity during peak periods of electricity use or when the sun is not shining or the wind is not blowing. Thus, the system may be utilized as an energy storage system or accumulator which is cost-effective and cheap to implement.

The process includes providing the bladder at a deep enough depth such that water or other fluid stored within the bladder is pressurized to a great enough pressure that will drive a turbine to produce electricity when controllably released. The process includes utilizing surplus electricity to fill the bladder and/or sink it to a deep enough depth to drive the turbines when a valve is opened which allows water or other fluid to be squeezed from within the bladder to drive a generator and produce electricity. The process may further comprise using a motor to turn a chain drive which in turn twists at least one screw causing the bladder to be pulled towards the bottom of the body of water in which the bladder is maintained. Control structures comprising microprocessors and programmable logic controllers and sensors may be utilized to control operation of the invention to maximize its efficiency.

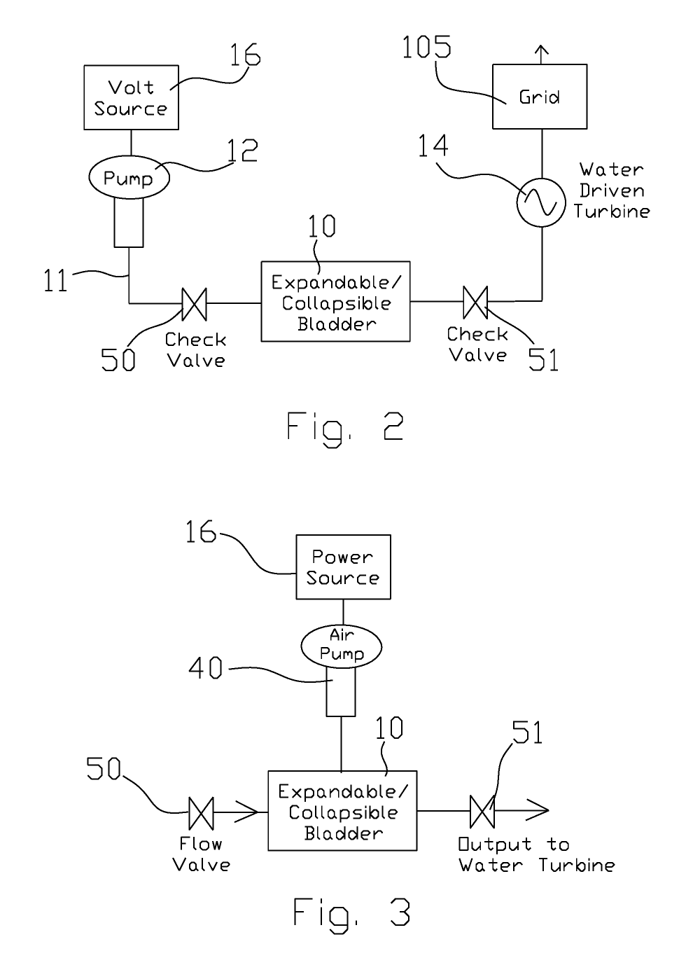

FIG. 2 shows an alternative embodiment of the invention wherein a power source 16, such as a wind turbine, solar array or battery bank, is used to pump water into a stationary and collapsible bladder that is attached to or near the bottom of a body of water to create a pressurized bladder 10. The bladder 10 is initially filled utilizing a pump 12 which fills the bladder during periods of excess electrical production. This bladder is then drained of its potential energy by opening a valve to direct water through a turbine which produces electricity. The electricity may be fed back onto the electric grid 105 at peak demand times. It should be noted that again that the collapsible bladder may be used as an emergency source of readily assessible potable water if it is filled with such. A check valve 50 is placed within the flexible conduit 11 between the pump 12 and the bladder 10 to ensure that pressurized water is directed towards the water driven turbine 14. A second electrically operable valve 51 may be provided between the bladder and the water driven turbine such that water within the output side of the conduit will not drain back into the bladder during filling operations. Like FIG. 1, the bladder 10 may be raised or lowered to increase or decrease the internal pressure of the bladder.

FIG. 3 shows a further embodiment of the invention. In this instance, a collapsible bladder 10 is affixed to a bottom or at a desired depth within a body of water. This bladder 10 is filled with water by first filling the bladder 10 with air via air pump 40. A valve 50 is opened allowing the trapped air within the bladder to escape while drawing surrounding water into the collapsible bladder. A turbine may be positioned between an inlet into the bladder and the exterior of the bladder to harness energy additional energy from pressurized water draining into the bladder as air is replaced with water in the bladder. Valve 51 releases fluid from within bladder 10 to drive a water turbine.

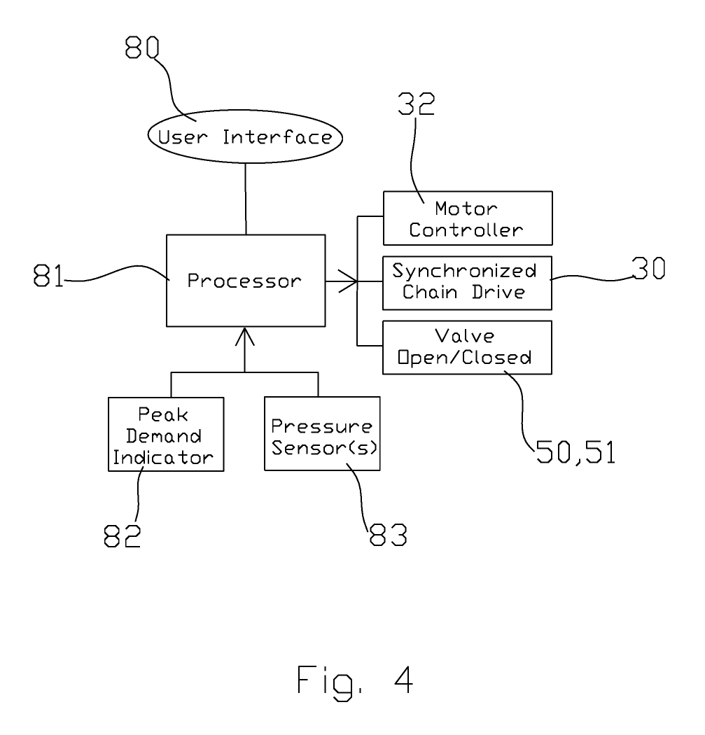

FIG. 4 shows an electrical schematic of the first embodiment and showing control circuitry associated with controlling the expansion and contraction of the various bladders as previously set forth. A user interface 80 which may include a keyboard, screen, laptop, tablet, smart phone, or the like which controls the processor 81. Processor 81 receives feedback from the system, and controls the operational function of the system such as filling or pressurizing the bladder. Some of the control features may include: turning on and off motor controller 32, operating synchronized chain drive; and, opening and closing selected valves 50, 51. There may be included in the invention, pressure sensors arranged on an exterior and/or interior of the bladder 83. Actuators that control the various motors, screw-drive, valves, turbines and other necessary parts for controlling operation of the invention are controlled by processor 81. Other sensory input may include automatically determining electrical demand and production and operating the invention to produce electricity during peak electrical demand periods via a peak electricity demand indicator 82.

It is to be understood that the invention is not limited to the exact construction illustrated and described above, but that various changes and modifications may be made without departing from the spirit and the scope of the invention as defined in the following claims. While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. An energy storage device comprising a collapsible bladder being arranged beneath a surface of a body of water, said collapsible bladder having a fluid arranged therein, said collapsible bladder being filled with the fluid when electricity rates are low in cost and thereafter released to drive a generator to create electricity when electricity rates rise in cost.

2. A system for storing electricity comprising:
a compressible bladder having a fluid arranged therein, said compressible bladder being deposited at a predetermined depth below a surface of a body of water and being filled with the fluid when electricity is being produced at a surplus;
a pump connected to said compressible bladder to pump fluid into the compressible bladder via a conduit;
a drive for submerging said bladder to the predetermined depth;
a generator coupled to the compressible bladder via the conduit to produce electricity by releasing the fluid from within the compressible bladder; and,
whereby the fluid within the compressible bladder is released to drive the generator to produce electricity as needed.

3. The system of claim 2 further comprising a diverter valve arranged with a common port connected to the conduit and a first switchable port connected to the pump and a second switchable port connected to the generator.

4. The system of claim 2 further comprising:
a voltage source coupled to a pump that pumps fluid into the compressible bladder at an operating depth below the surface of the body of water;
a check valve arranged in line between said pump and the compressible bladder and being arranged to allow only fluid to be pumped into the compressible bladder.

5. The system of claim 4 further comprising a second check valve arranged between the compressible bladder and the generator.

6. The system of claim 5 wherein said second check valve is an electrically operated valve.

7. The system of claim 2 wherein the drive for submerging said bladder to depth comprises a motor coupled to a chain drive which twists at least one screw to descend the bladder towards a bottom of the body of water.

8. The system of claim 2 wherein the drive for submerging said bladder to depth comprises a motor driving a synchronized chain drive, said motor comprising a power cord that is connected above the surface of the body of water to a power source.

9. The system of claim 8 wherein said power source is an array of solar cells.

10. The system of claim 8 wherein said power source is a wind turbine.

11. A system for storing electricity comprising:
a compressible bladder having a fluid arranged therein, said compressible bladder being fastened to a bottom of a body of water at a predetermined depth below a surface of the body of water and being filled with the fluid when electricity is being produced at a surplus;
a pump connected to the compressible bladder to fill the compressible bladder;
a first conduit connected between the compressible bladder and the pump and which allows fluid to flow therebetween;
a generator coupled to the compressible bladder to produce electricity by releasing the fluid from within the compressible bladder; and,
a second conduit connecting said compressible bladder to the generator;
whereby the fluid within the compressible bladder is released to drive the generator to produce electricity as needed.

12. The system of claim 11 further comprising a check valve arranged in-line in the first conduit and which prevents fluid from flowing from the compressible bladder back into the pump.

13. The system of claim 11 further comprising a check valve arranged in-line in the second conduit to prevent fluid from flowing from the generator back into the compressible bladder.
